(19) United States
(12) Patent Application Publication
(10) Pub. No.: US 2014/0148296 A1
(43) Pub. Date: May 29, 2014

(54) Converting Motorcycle Final Drive

(71) Applicant: SWAMP WORKS, INC., Miami, FL (US)

(72) Inventor: Luis PEREZ, Miami, FL (US)

(73) Assignee: SWAMP WORKS, INC., Miami, FL (US)

(21) Appl. No.: 13/686,146

(22) Filed: Nov. 27, 2012

(51) Int. Cl. F16H 48/06

(52) U.S. Cl. CPC F16H 48/06
USPC 475/221

(57) ABSTRACT

A vehicle drive system includes a housing, a sun gear, a planet gear carrier, and planetary gears supported by the planet gear carrier and engaged with the sun gear. An output gear includes a ring gear engaged with the plurality of planetary gears, connected to and forming a part of a differential having a rotatable differential case. An interlock is configured to affix the planetary gear carrier to the housing in a first position, and to affix the sun gear to the planet gear carrier in a second position, the axles rotating in a first direction in a first position, and a second direction in a second position. An actuating system moves the planet gear carrier between the first and second positions. A kit includes the transmission and adapts a two wheeled motorcycle to a three wheeled motorcycle.

### FIELD OF THE INVENTION

The invention relates to a differential for a three wheeled motor vehicle, and particularly a final drive or gear system for adapting a two wheeled motorcycle to a three wheeled motorcycle, including a reverse gear set.

### BACKGROUND OF THE INVENTION

Commercially retailed motorcycles are commonly sold with a forward-only operating transmission. Providing a reverse gear is often deemed unnecessary, because many motorcycles are small enough that a rider can physically push the motorcycle in reverse, using the rider's legs while sitting for example. Some motorcycles are very large, however, and it is difficult, particularly for a smaller rider, to physically push the vehicle in reverse. Should a motorcycle be converted into a tricycle, or “trike”, having an extended rear axle for supporting two wheels instead of just one, it becomes further unfeasible for a rider to physically push the vehicle in reverse.

Methods for converting motorcycles to tricycles are known, and kits providing for the conversion are commercially available. At least in part because converting a motorcycle to a tricycle will substantially increase the weight and bulk of the vehicle, a conversion may further modify the motorcycle with a means to reverse the vehicle.

The art described in this section is not intended to constitute an admission that any patent, publication or other information referred to herein is “prior art” with respect to this invention, unless specifically designated as such. In addition, this section should not be construed to mean that a search has been made or that no other pertinent information as defined in 37 CFR §1.56(a) exists.

### SUMMARY OF THE INVENTION

The disclosure provides for a vehicle final drive system and a kit for converting a two wheeled motorcycle to a three wheeled motorcycle, as described herein.

In accordance with an embodiment of the disclosure, a vehicle transmission or drive system comprises a housing; a sun gear driven by a motor of the vehicle; —a planet gear carrier; —a plurality of planetary gears rotatably mounted to the planet gear carrier and engaged with the sun gear; —an output gear including a ring gear engaged with the plurality of planetary gears, a rotatable differential case connected to the ring gear, one or more spider gears rotatable in connection with the differential case, and two side gears each connected to an axle; and an interlock configured to affix the planet gear carrier to the housing in a first position, whereby the axles rotate in a first direction when the sun gear is rotated in a first direction, the interlock further configured to affix the sun gear to the planet gear carrier in a second position, whereby the axles rotate in a second direction when the sun gear is rotated in a first direction.

In embodiments thereof, the sun gear is a shaft extending into the housing and, in some embodiments, may further comprise a first end plate and a second end plate affixed to the housing, the axle extending through an aperture in the first end plate, the shaft extending through an aperture in the second end plate.

Additional embodiments include, a housing cover attachable to the housing, the attached housing cover enveloping the planet gear carrier and the output gear.

It should be understood that, in some embodiments, the planet gear carrier is configured to move between a first position and a second position in a direction substantially parallel to the axle. The disclosure thus serves to switch axle rotation between a first direction and a second direction where, in some embodiments, the first direction of axle rotation is associated with the vehicle moving in reverse, and the second direction of axle rotation is associated with the vehicle moving forward.

In a yet further embodiment, the final drive system includes a first set of dogs provided on a first end of the planet gear carrier to be coupled with the output gear in a first position, and a second set of dogs provided on a second end of the planet gear carrier to affix the planet gear carrier to the housing in a second position. Other embodiments include a first set of teeth provided on a first end of the planet gear carrier to be coupled to mating teeth of the output gear in a first position, and a second set of teeth provided on a second end of the planet gear carrier to affix the planet gear carrier to mating teeth of the housing in a second position.

In another embodiment of the disclosure, a vehicle final drive system comprises a housing; a sun gear driven by a motor of the vehicle, the sun gear including an internal bore; a planet gear carrier; a plurality of planetary gears rotatably mounted to the planet gear carrier and engaged with the sun gear; an output gear including a ring gear engaged with the plurality of planetary gears, a rotatable differential case connected to the ring gear, one or more spider gears rotatable in connection with the differential case, and two side gears each connected to an axle; an actuating system for moving the planet gear carrier between a first position and a second position, the actuating system including at least one actuator member connected to the planet gear carrier, and an actuator and a biasing element associated with each at least one actuator, the actuator configured to exert an actuating force against the actuator member, the biasing element configured to exert a resisting force against the actuator member in a direction substantially opposing the actuating force; and—an interlock configured to affix the planet gear carrier to the housing in the first position, whereby the axles rotate in a first direction when the sun gear is rotated in a first direction, the interlock further configured to affix the sun gear to the planet gear carrier in the second position, whereby the axles rotate in a second direction when the sun gear is rotated in a first direction.

In an embodiments where an actuating system is provided, the actuating system may include, in some embodiments, an inner plate, the at least one actuator member connected to the inner plate, the inner plate affixed to the planet gear carrier and movable between the first and second positions. In additional embodiments, the at least one actuator member is an actuator pin extending through an aperture in the inner plate, and the associated actuator and biasing element are provided proximate to opposing sides of the inner plate. In further embodiments, the vehicle final drive system includes at least one thrust bearing provided proximate to the inner plate and the planet gear carrier configured to rotatably bear the planet gear carrier against the actuating force and the resisting force.

The disclosure also provides for a kit for converting a two wheeled motorcycle to a three wheeled motorcycle, the kit comprising: a housing mountable to a swing arm of the motorcycle; a sun gear supported within the housing and driven by a motor of the vehicle; a planet gear carrier; a plurality of planetary gears rotatably mounted to the planet gear carrier and engaged with the sun gear; an output gear including a rotatable differential case having a ring gear engaged with the plurality of planetary gears at a first end, and one or more spider gears rotatably mounted at a second, opposite end, and two side gears matingly engaged with the one or more spider gears, each side gear connected to a rear axle; an actuating system for moving the planet gear carrier between a first position and a second position, the actuating system including at least one actuator member connected to the planet gear carrier, and an actuator and a biasing element associated with each at least one actuator, the actuator configured to exert an actuating force against the actuator member, the biasing element configured to exert a resisting force against the actuator member in a direction substantially opposing the actuating force; and an interlock configured to affix the planet gear carrier to the housing in the first position, whereby the axles rotate in a first direction when the sun gear is rotated in a first direction, the interlock further configured to affix the sun gear to the planet gear carrier in the second position, whereby the axles rotate in a second direction when the sun gear is rotated in a first direction.

In some embodiments, the kit further comprises user control means for activating and deactivating the actuator of the actuating system. In additional embodiments, the actuating system includes an inner plate, the at least one actuator member connected to the inner plate, the inner plate affixed to the planet gear carrier and movable between the first and second positions.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 depicts a top view of a swing arm and final drive as presently known in the art;

FIG. 2 depicts a top view of a reversible gear system in accordance with the disclosure engaged with the swing arm and final drive as shown in FIG. 1;

FIG. 3 depicts a top view of the reversible gear system as shown in FIG. 2 installed to a support frame;

FIG. 4 depicts an exploded view of the internal plates of the housing of the reversible gear system as shown in FIG. 2;

FIG. 5 depicts an exploded view of the internal components of the housing of the reversible gear system as shown in FIG. 2;

FIG. 6 depicts a front view of the installed reversible gear system as shown in FIG. 3 with the bottom of the housing removed to illustrate the internal features;

FIG. 7A depicts a schematic view of a final drive of the disclosure, including a first gear set and a second gear set in a first position, for forward rotation of wheel axles;

FIG. 7B depicts the schematic view of FIG. 7A, the second gear set in a second position, for reverse rotation of the wheel axles;

FIG. 8 depicts a cross-section of the installed reversible gear system as shown in FIG. 3 from a bottom view;

FIG. 9 depicts the gears of the reversible gear system rotating in a forward direction while in first position; and

FIG. 10 depicts the gears of the reversible gear system rotating in reverse direction while in a second position.

### DETAILED DESCRIPTION OF THE INVENTION

In the description which follows, any reference to direction or orientation is intended primarily and solely for purposes of illustration and is not intended in any way as a limitation to the scope of the present invention. Also, the particular embodiments described herein are not to be considered as limiting of the present invention.

FIG. 1 depicts the rear portion of a shaft driven motorcycle, as may be found in the prior art. A swing arm 110, also referred to as a swing fork or a pivot fork, extends towards the rear of the vehicle and is coupled to a final drive 120. FIG. 1 illustrates a two sided swing arm, however a single sided swing arm is contemplated as modifiable within the disclosure. Conversion of a two sided swing arm 110 is advantageously resistant to the additional torquing forces attributed to a conversion from a single wheel axis 114 to a double wheel axis 114A, such as when converting the vehicle from a motorcycle to a motorized tricycle. Contained in the final drive 120 is a final drive gear (not shown) connected to a drive shaft (not shown), typically within the swing arm. Attachment points 122 for the suspension, as well as a pin 124 for attaching suspension elements, are additionally shown, as commonly found in commercially sold motorcycles. Coupled to the final drive 120 is a rear wheel axle 114, which supports rotation of a wheel mounted to the axle.

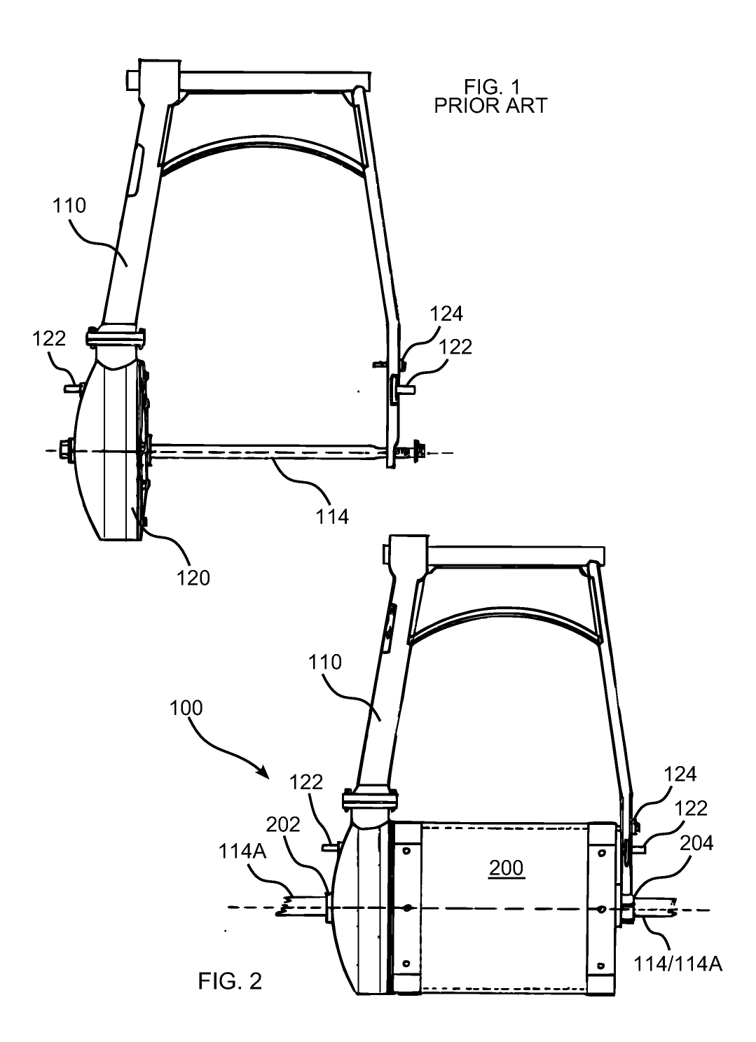

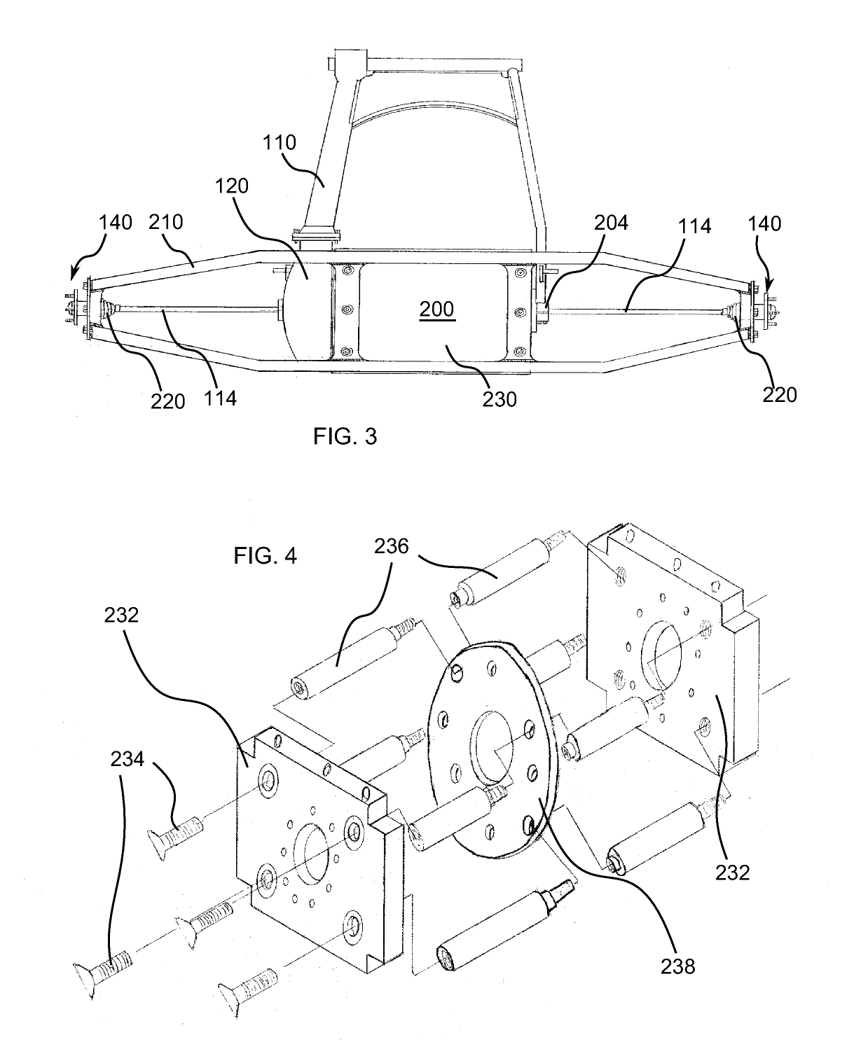

In reference now to FIGS. 2 and 3, a drive assembly 100 includes a reversing gear housing 200, in accordance with the disclosure, is mounted to the rear of the vehicle. A housing cover 230 is provided for enveloping, protecting, and/or at least partially containing the contents of housing 200. An O-ring 282 is provided proximate to each end of cover 230 in order to seal cover 230 to housing 200. Cover 230 may further include a sealable opening, such as a hinged window, to provide access to the components within housing 200 without requiring removal of the cover, thereby facilitating more cost and time efficient maintenance, including for example lubrication. As shown, the dimensions of a back cover 254 of first gear set 250 can be adjusted in accordance to the dimensions of swing arm 110 being used, particularly the width of the swing arm. Housing 200 may be advantageously positioned in connection with frame 210, on the rear of the vehicle, in order to facilitate access to the inside of housing 200, for ease of replacing parts, and for other maintenance, including adjustment. As will be evident from the disclosure, while contents, gears, and gear sets within housing 200 rotate with respect to a wheel axis extending along wheel axle 114/114A, housing 200 is rotationally fixed with respect to rotation about the wheel axis by securing means disclosed herein, such as fastening to frame 210.

In one embodiment, the support frame 210 is attached to housing 200 by ⅜″ grade eight bolts, although other bolts and fasteners may be utilized in accordance with the disclosure. A permanent attachment, such as by welding or spot welding housing 200 to frame 210, is also contemplated within the disclosure. In one embodiment frame 210 is advantageously constructed from chromoly steel and end plates 210 are constructed from cold rolled steel, however other materials of sufficient strength, durability, and performance are contemplated within the disclosure.

The dimensions of cover 230 may be advantageously adjustable, either before or after manufacturing, to accommodate the dimensional specifications of the original components of the vehicle. For example, different models of motorcycles have different dimensions for their swing arms 110. By advantageously bolting, or removably fastening by other means known or to be developed, cover 230 to housing 200, the housing 200 may be modified to conform for use in a variety of vehicles with a variety of dimensions. Although any known method of fastening may be used for securing housing 200 and cover 230, it is advantageous for housing 200 to attach to final drive 120 using the same bolts provided from the factory production of the drive shaft model vehicle. As will be evident throughout the disclosure, the ease of use and installation of housing 200, as well as the simplicity of several elements in the various embodiments of the disclosure, advantageously reduce installation and maintenance time, as well as reduce installation and maintenance costs.

In order to aide alignment of housing 200, a two-piece clamp 204 advantageously secures cover 230 with swing arm 110. Clamp 204 secures and aligns housing 200 along wheel axle 114A and with respect to final drive 120. Although clamp 204 is illustrated on the opposite side of final drive 120, it is contemplated within the disclosure to provide clamp 204 on the final drive side in some embodiments, or to provide a plurality of clamps 204 on each one or both sides of housing 200 in alternative embodiments. An oil seal 202 may be further provided on one or both sides of swing arm 110 where axle 114 exits from housing 200.

In accordance with the disclosure, drive assembly 100 advantageously includes support for a variety of safety features that may be provided with commercially sold motorcycles and other motor vehicles contemplated within the disclosure. On some vehicles, for example, a pin 124 is provided on each side of swing arm 110 for supporting a brake caliper (not shown), thereby restricting rotation when the brakes are applied. Although the dimensions of pin 124 vary from model to model, a 14 mm threaded pin is a common dimensional example. Pins 124, for example, may be advantageously used to help maintain alignment of housing 200, as best illustrated in FIG. 2.

The original suspension system of the vehicle may also be advantageously utilized, although it is contemplated that a variety of suspension systems may be utilized with drive assembly 100 in accordance with the disclosure. As illustrated, a double sided swing arm 110 is utilized which provides significantly greater twisting torque support than a single sided swing arm, although both embodiments are contemplated within the disclosure.

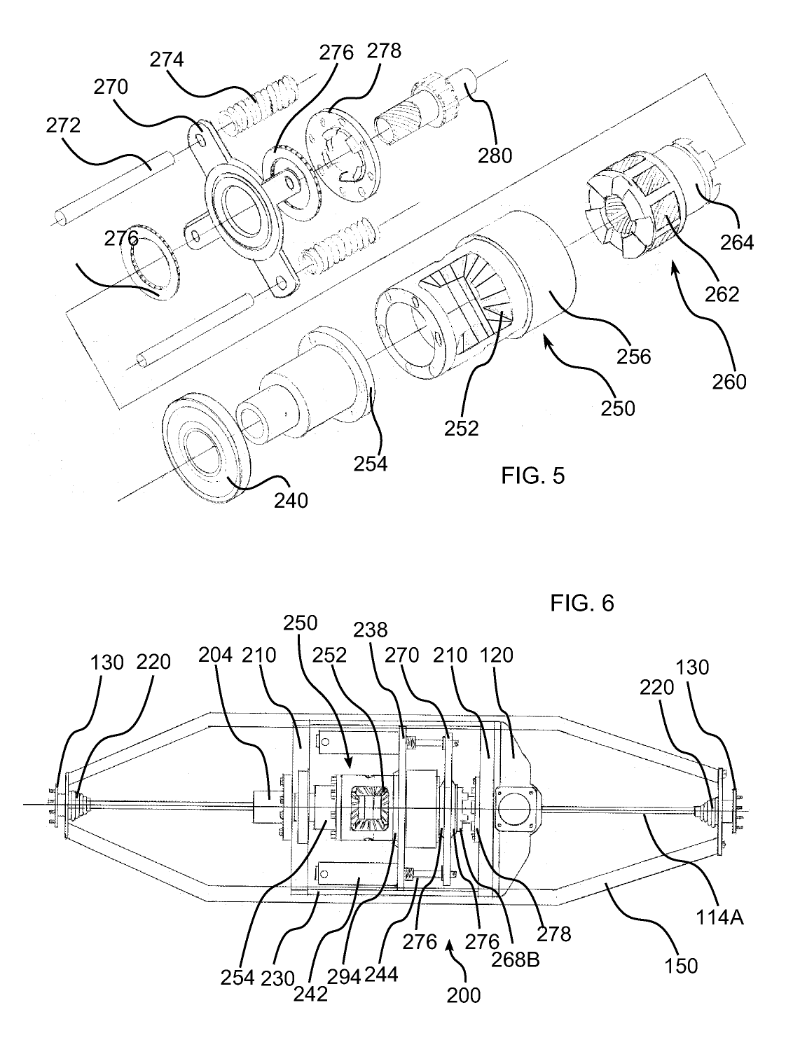

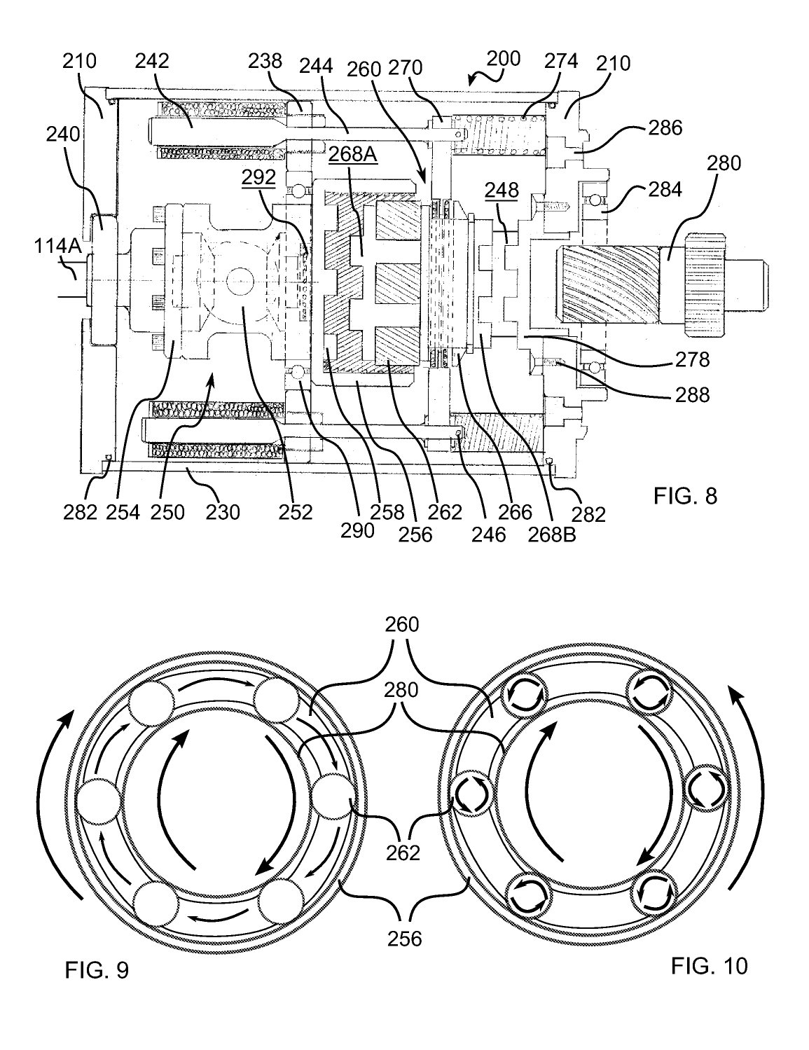

Referring now to FIGS. 4-10, a reverse drive assembly 100 includes a reversing differential housing 200 having a rotatable differential case or first gear set 250 that is positioned proximate a planet gear carrier or second rotatable gear set 260, and a motor driven shaft 280 rotatably driven by final drive 120. Throughout the disclosure, differential case 250 may also be referred to as a first or output gear set 250, and planet gear carrier 260 may also be referred to as the second or input gear set 260. Shaft 280, as depicted in the illustrated embodiment, includes a spiral cut gear configured for meshing with planetary gears 262 as described herein, on a first end, and having a pinion, for engaging a final drive gear, thereby transmitting power as described herein, on a second end. Shaft 280 further includes an internal bore for accommodating the wheel axle 114/114A. A set of differential gears 252, including spider gears and a side gear connected to each wheel axle 114/114A connected to the differential case 250, are provided in first gear set 250 and function, in an embodiment of the disclosure, as a differential for wheel axles 114/114A. In some embodiments, such as a two wheel hub 130 embodiment, wheel axle 114/114A may be divided into a first part and a second part, each part connected to a respective wheel hub 130. In this embodiment, a first part of axle 114A may extend through a first end plate 232, while a second part of axle 114A extends through an internal bore of shaft 280. A variety of differential mechanisms, known or to be developed, are contemplated to be used in place of or together with spider gear 252, in accordance with the disclosure, including, but not limited to, limited slip, locking, automatic torque biasing, sliding pin, sliding cam, spool, epicyclic, and spur-gear differentials, as well as electronically aided differentials, such as those found in anti-lock braking systems.

At least one planetary gear 262 is housed in planet gear carrier 260, each planetary gear 262 advantageously including spiral cut gears for quietness and reliability. In the embodiment illustrated, there are six (6) equally spaced planetary gears, provided in a casing of the second gear set 260, although other numbers of gears may be used. Each planetary gear 262 is externally splined or grooved to cooperate or mesh with an internal ring gear 256 provided on a second end of first gear set 250. Each planetary gear is also splined to mesh with the external splines of locking motor output shaft 280. Integrally situated and extending from a first end of the second gear set casing 260 is a port or interlock member 268A, comprising a set of locking dogs, teeth, or similar locking extrusions, which can lock a port 258, comprising a set of matable extrusions, provided on a second end of first gear set 250. Projecting from a second end of gear set casing 260 is a port or interlock member 268B, which is interlockable with extrusions on a planetary gear port 278. In one embodiment, second gear set 260 is sleeved with a bronze bushing. As a result of shifting planet gear carrier 260 between a first and second position, an interlock 268 including interlock members 268A/268B provided on carrier 260 permits the axle 114/114A to rotate in either a first or second direction, as described herein.

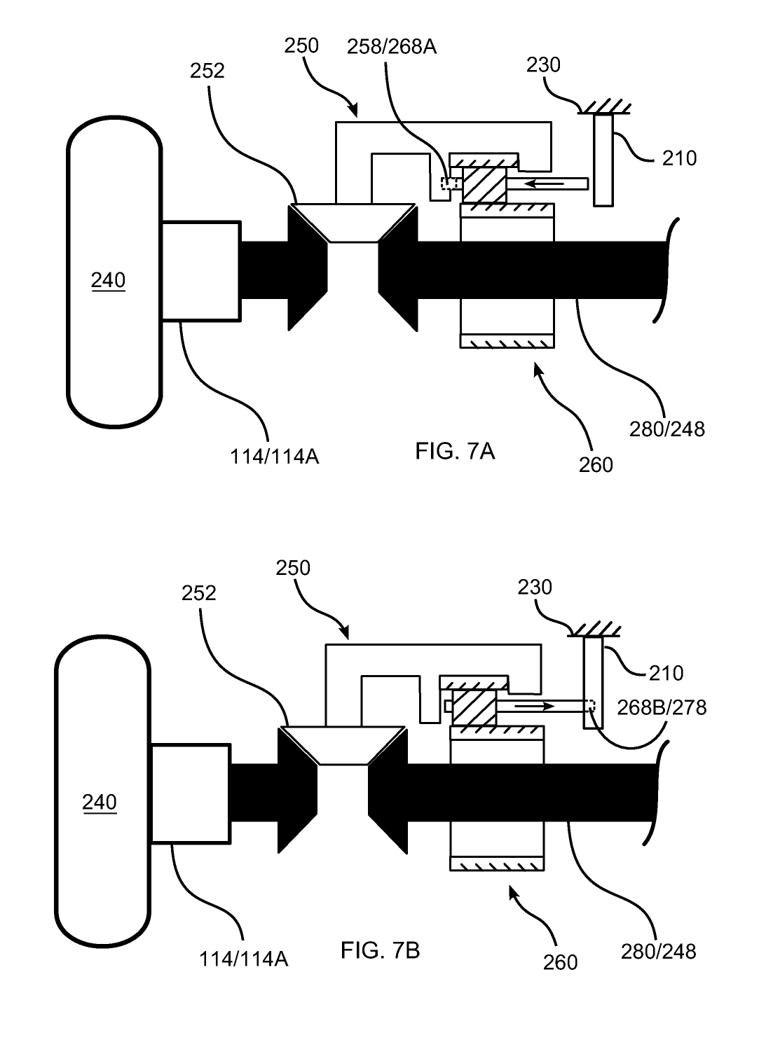

Shifting between a forward direction, associated with a first rotation direction of wheel axle 114/114A, and a reverse direction, associated with a second rotation direction of wheel axle 114/114A, is advantageously achieved by linearly displacing planetary gear carrier 260 between a first position, thereby rotatably coupling or locking ports 258 and 268A, and a second position, thereby rotatably coupling or locking ports 268B and 278. In reference to FIGS. 7-9, it should be noted that first positions and first ends are associated with the left direction of the drawing, and second positions and second ends are associated with the right direction of the drawing. Second gear set 260 may be aligned by sliding over an output shaft 248.

Linear displacement of second gear set 260 is achieved through an actuating system including actuation of at least one solenoid 242 held in alignment by inner plate 238. The solenoids 242 illustrated are push-type and mounted substantially parallel to axle 114/114A, however other known or to be developed pumps or actuators in place of push-type solenoids 242 may also be used, so long as the actuating component may actuate a force as described. Additional embodiments contemplate the actuators situated at an angle relative to the wheel axis, so long as the force of the actuator results in substantially linear displacement in the direction of the wheel axis. Using user control means not illustrated, such as an electrical switch at the handlebar of the vehicle, solenoids 242 are actuated to force an associated actuator member 244, a solenoid plunger in the embodiment illustrated, from a first position to a second position along a substantially linear path in association with the wheel axis. In the embodiment illustrated, the substantially linear path is substantially parallel to the wheel axle, however other linear and nonlinear directions between the first and second positions are contemplated within the disclosure. Each plunger 244 is coupled to a thrust bearing plate 270 such that an actuation of solenoids 242 results in a displacement of plate 270 from the first position to the second position. It should be understood that certain safety interlocks may be provided, for example in cooperation with an onboard computer, to prevent shifting when the vehicle is in motion, or when an operating speed (RPM) of the motor is excessively high.

Second gear set 260 is seated in a central aperture of plate 270 and is freely rotatable about the wheel axis, while plate 270 is rotationally fixed by a plurality of pins 272, although plungers 244 may also act to rotationally fix plate 270 on their own or with the assistance of one or more pins 272. A thrust bearing 276 is advantageously provided on each side of plate 270 to permit rotation of gear set 260 while advantageously resisting high and repetitive axial loadings that may be exerted during shifting between first and second positions, as well as natural forces exerted during operation of the vehicle; however other bearing types are contemplated within the disclosure. A spacer 266 may also be provided to maintain alignment of second gear set 260 with plate 270.

In order to shift from the second position back to the first position, solenoids 242 are deactuated, or depressurized in some embodiments, and biasing members or springs 274 exert their stored energy, acquired during displacement from first to second position, thereby pushing plate 270, and thus second gear set 260, back to the first position. Springs 274 may be provided at various points along the second side of plate 270, including proximate to plungers 244, pins 272, a combination thereof, or other positions reasonably determined by a person of ordinary skill sufficient to force plate 270 from the second position to the first position. Where the springs are provided in a position opposite to plungers 244, a pin 246 may be provided to restrict slippage or misalignment of spring 274. In the embodiment illustrated, two (2) pins 272 and two (2) plungers 244 are illustrated, with a biasing member 244 associated with each.

Two support frames 210 are provided on each end of gear set 200, with inner plate 238 connected in between by a plurality of interlocking support spacers or pins 236. In some embodiments, a screw 234 associated with each spacer 236 is used to secure or lock spacer 236 to end plates 210. Frames 210 and plate 238 are rotationally fixed within housing 200. The housing frame or shell 230 extends between frames 210, situated or seated in a lip or groove at the edge of each frame 210, however in some embodiments housing 230 envelops and extends over frames 210 as well.

Frames 210 and inner plate 238 are rotationally stationary, with respect to rotation in a first or second direction about wheel axle 114/114a, while other components rotate as described herein. First gear set 250 is rotatable by passing plate 238 through bore 290. A bore bearing 294 is provided externally about first gear set 250 to help hold and maintain concentricity, and a thrust bearing 292 provided, along with a biased washer, to remove clearance. Rotatably coupled on a first end of first gear set 250 is a back cover 254, a portion of which extends through frame 210 and is rotatable by means of boring 240. As discussed above, second gear set 260 is rotatably passed through thrust bearings 276, and planetary gears 262 are individually rotatable about their individual axis within second gear set 260. Shaft 280 is rotatably driven by final drive 120, and freely rotates while projecting through frame 210 by means of bearing 284.

Specifically in reference now to FIGS. 7-9, wheel axle 114a is rotatable, with respect to a wheel axis longitudinally extending through the wheel axle 114a, in a forward direction when second gear set 260 is positioned in first position, and wheel axle 114a is rotatable in a reverse direction when second gear set 260 is in a second position. In an embodiment of the disclosure, locking shaft 280 is rotatably driven in a first direction, associated with the forward direction of rotation. Externally provided on shaft 280 is a series of grooves or splines in meshed communication with planetary gears 262. The splines associated with shaft 280 extend over a sufficient length of the shaft to permit rotatable engagement between shaft 280 and planetary gears 262 in both first and second positions.

In a first position, shaft 280 is rotated by final drive 120 in a first angular direction, illustrated as counter-clockwise. Shaft 280 applies an angular momentum thereby rotating gear set 260 and internally splined ring gear 256, which are rotationally locked with each other with respect to rotation about the wheel axis through engagement between ports 258 and 268A. In a second or reverse position, gear set 260 is rotationally fixed with respect to the wheel axis through engagement between ports 268B and 278. Accordingly, shaft 280 functions as a sun gear and rotates planetary gears 262 in a second direction, illustrated as clockwise, which in turn rotate internal ring gear 256 is a second direction. Thus, in first position ring gear 256 is rotated in a first direction and in second position ring gear 256 is rotated in a second direction.

In both positions, the rotation of ring gear 256 results in rotation of first gear set 250 with respect to the wheel axis. Gear set 250 remains fixed in rotation to wheel axle 114A in either the first or second position, thereby providing output rotation to wheel hubs 130. In another embodiment, gear set 250 is coupled to an output shaft which rotates in connection with wheel axle 114A. A series of spider gears 252, advantageously functioning as a differential, are shown in the illustrated embodiment, however it should be understood that gear set 250 may be directly connected to an output shaft or wheel axle 114/114A.

In the reverse or second position, the gear ratio resulting in power transmitted to the output shaft 248 or wheel axle 114A is advantageously lower than the gear ratio provided in the forward or first position. This reduced gear ratio is advantageously accomplished through utilization of planetary gears 262 in the second position. The gear ratio between an input rotation along shaft 280 and the output rotation to the axle 114/114A may be calculated by means known to a person of ordinary skill in the art, however it should be clear that the lowered ratio in the second position permits more power to be transmitted to wheel axle 114/114A and wheel hubs 130. The advantageously enhanced gear ratio permits the vehicle to be driven in reverse over a ramped incline, such as backing the vehicle into a trailer bed, without difficulty.

It is advantageous that reversing transmission 200 is applicable to standard or commonly obtained automobile wheel hubs 130, bearings, and other components associated with the rear portion of the vehicle. Wheel axle 114/114A may be advantageously custom made from 4140 pre-hardened steel in order to accommodate the wheel hubs 130 designated by the customer, however the original axle 114 may be utilized as well in some embodiments. As such, the embodiments disclosed may be adapted to a variety of commercially sold motorcycles, including motorcycles based upon the metric system.

The simplicity of the design permits the present embodiments of the disclosure to be installed substantially more quickly and readily than “trike” conversions of the prior art. For example, trike builders typically estimate eight (8) to fourteen (14) hours of installation time, while the embodiments of the present disclosure can be installed in less than one hour. An installation of the reverse system 200 is accomplished by replacing the bolts supporting the frame 210 and swing arm 110 as described herein, and adjusting or extending of the brake line (not shown), if needed.

The advantageous simplicity of the embodiments disclosed is further apparent in that shifting may be accomplished through a single switch actuating and deactuating the solenoids 242. The design is thus an improvement over lever operated reversing transmissions associated with gear modifications to the actual transmission of the automobile. The embodiments disclosed are also an improvement over designs including external starter motors which turn a ring gear, providing limited power in a reverse gear, as opposed to the lower gear ratio and enhanced power provided in the present disclosure, as described herein.

All references cited herein are expressly incorporated by reference in their entirety. In addition, unless mention was made above to the contrary, it should be noted that all of the accompanying drawings are not to scale. There are many different features to the present invention and it is contemplated that these features may be used together or separately. Thus, the invention should not be limited to any particular combination of features or to a particular application of the invention. Further, it should be understood that variations and modifications within the spirit and scope of the invention might occur to those skilled in the art to which the invention pertains. Accordingly, all expedient modifications readily attainable by one versed in the art from the disclosure set forth herein that are within the scope and spirit of the present invention are to be included as further embodiments of the present invention.

### REFERENCE LIST

110 swing arm
112 pin
114 single wheel axle
114A double wheel axle
120 final drive
122 suspension attachment point
124 pin
130 wheel hubs
150 support frame
200 reversible final drive
202 oil seal
204 clamp
210 support frame
220 constant velocity joint
230 housing shell
232 end plate
234 bolt
236 support spacer
238 inner plate
240 bearing
242 solenoid
244 solenoid plunger
246 pin
248 output shaft
250 first gear set
252 spider gears
254 back cover
256 internal ring gear
260 second gear set
262 planetary gears
264 snap ring
266 spacer
268A port
268B port
270 thrust bearing plate
272 pin
274 spring
276 thrust bearing
278 planetary gear port
280 locking shaft
282 o-ring
284 bearing
286 fastener
288 fastener
290 bore
292 thrust bearing
294 bore bearing

What is claimed is:

1. A vehicle drive system comprising:
a housing;
a sun gear driven by a motor of the vehicle;
a planet gear carrier;
a plurality of planetary gears rotatably mounted to the planet gear carrier and engaged with the sun gear;
an output gear including a ring gear engaged with the plurality of planetary gears, a rotatable differential case connected to the ring gear, one or more spider gears rotatable in connection with the differential case, and two side gears each connected to an axle; and
an interlock configured to affix the planet gear carrier to the housing in a first position, whereby the axles rotate in a first direction when the sun gear is rotated in a first direction, the interlock further configured to affix the sun gear to the planet gear carrier in a second position, whereby the axles rotate in a second direction when the sun gear is rotated in a first direction.

2. The vehicle drive system of claim 1, wherein the sun gear is a shaft extending into the housing.

3. The vehicle drive system of claim 2, further comprising a first end plate and a second end plate affixed to the housing, the axle extending through an aperture in the first end plate, the shaft extending through an aperture in the second end plate.

4. The vehicle drive system of claim 1, further comprising a housing cover attachable to the housing, the attached housing cover enveloping the planet gear carrier and the output gear.

5. The vehicle drive system of claim 1, wherein the planet gear carrier is configured to move between a first position and a second position in a direction substantially parallel to the axle.

6. The vehicle drive system of claim 1, wherein the interlock includes
a first set of dogs provided on a first end of the planet gear carrier to be coupled with the output gear in a first position, and
a second set of dogs provided on a second end of the planet gear carrier to affix the planet gear carrier to the housing in a second position.

7. The vehicle drive system of claim 1, wherein the first direction of axle rotation is associated with the vehicle moving in reverse, and the second direction of axle rotation is associated with the vehicle moving forward.

8. A vehicle transmission system comprising:
a housing;
a sun gear driven by a motor of the vehicle, the sun gear including an internal bore;
a planet gear carrier;
a plurality of planetary gears rotatably mounted to the planet gear carrier and engaged with the sun gear;
an output gear including a ring gear engaged with the plurality of planetary gears, a rotatable differential case connected to the ring gear, one or more spider gears rotatable in connection with the differential case, and two side gears each connected to an axle;
an actuating system for moving the planet gear carrier between a first position and a second position, the actuating system including
at least one actuator member connected to the planet gear carrier, and
an actuator and a biasing element associated with each at least one actuator, the actuator configured to exert an actuating force against the actuator member, the biasing element configured to exert a resisting force against the actuator member in a direction substantially opposing the actuating force; and
an interlock configured to affix the planet gear carrier to the housing in the first position, whereby the axles rotate in a first direction when the sun gear is rotated in a first direction, the interlock further configured to affix the sun gear to the planet gear carrier in the second position, whereby the axles rotate in a second direction when the sun gear is rotated in a first direction.

9. The vehicle transmission system of claim 8, wherein the sun gear is a shaft extending into the housing.

10. The vehicle transmission system of claim 9, further comprising a first end plate and a second end plate affixed to the housing, the axle extending through an aperture in the first end plate, the shaft extending through an aperture in the second end plate.

11. The vehicle transmission system of claim 8, wherein the rotatable differential case includes the one or more spider gears a first end, and the ring gear at a second, opposite end.

12. The vehicle transmission system of claim 8, wherein the planet gear carrier is configured to move between a first position and a second position in a direction substantially parallel to the axle.

13. The vehicle transmission system of claim 8, wherein the interlock includes
a first set of teeth provided on a first end of the planet gear carrier to be coupled to mating teeth of the output gear in a first position, and
a second set of teeth provided on a second end of the planet gear carrier to affix the planet gear carrier to mating teeth of the housing in a second position.

14. The vehicle transmission system of claim 8, wherein the first direction of axle rotation is associated with the vehicle moving in reverse, and the second direction of axle rotation is associated with the vehicle moving forward.

15. The vehicle transmission system of claim 8, the actuating system further including an inner plate, the at least one actuator member connected to the inner plate, the inner plate affixed to the planet gear carrier and movable between the first and second positions.

16. The vehicle transmission system of claim 15, wherein the at least one actuator member is an actuator pin extending through an aperture in the inner plate, and the associated actuator and biasing element are provided proximate to opposing sides of the inner plate.

17. The vehicle transmission system of claim 15, further comprising at least one thrust bearing provided proximate to the inner plate and the planet gear carrier configured to rotatably bear the planet gear carrier against the actuating force and the resisting force.

18. A kit for converting a two wheeled motorcycle to a three wheeled motorcycle, the kit comprising:
a housing mountable to a swing arm of the motorcycle;
a sun gear supported within the housing and driven by a motor of the vehicle;
a planet gear carrier;
a plurality of planetary gears rotatably mounted to the planet gear carrier and engaged with the sun gear;
an output gear including a rotatable differential case having a ring gear engaged with the plurality of planetary gears at a first end, and one or more spider gears rotatably mounted at a second, opposite end, and two side gears matingly engaged with the one or more spider gears, each side gear connected to a rear axle;
an actuating system for moving the planet gear carrier between a first position and a second position, the actuating system including
at least one actuator member connected to the planet gear carrier, and
an actuator and a biasing element associated with each at least one actuator, the actuator configured to exert an actuating force against the actuator member, the biasing element configured to exert a resisting force against the actuator member in a direction substantially opposing the actuating force; and
an interlock configured to affix the planet gear carrier to the housing in the first position, whereby the axles rotate in a first direction when the sun gear is rotated in a first direction, the interlock further configured to affix the sun gear to the planet gear carrier in the second position, whereby the axles rotate in a second direction when the sun gear is rotated in a first direction.

19. The kit according to claim 18, further comprising user control means for activating and deactivating the actuator of the actuating system.

20. The kit according to claim 18, the actuating system further including an inner plate, the at least one actuator member connected to the inner plate, the inner plate affixed to the planet gear carrier and movable between the first and second positions.
